(19) United States
(12) Patent Application Publication
(10) Pub. No.: US 2023/0323150 A1
(43) Pub. Date: Oct. 12, 2023

(54) SUPERHYDROPHOBIC COMPOSITE AND MULTIFUNCTIONAL APPLICATIONS THEREOF

(71) Applicant: Council of Scientific & Industrial Research, New Delhi (IN)

(72) Inventors: Shankar Pooppanal SREEJITH, Thiruvananthapuram (IN); Nirmala ANJALI, Thiruvananthapuram (IN); Unnikrishnan Nair Saraswathy HAREESH, Thiruvananthapuram (IN); Ayyappanpillai AJAYAGHOSH, Thiruvananthapuram (IN)

(21) Appl. No.: 18/025,156

(22) PCT Filed: Sep. 8, 2021
(86) PCT No.: PCT/IN2021/050878

§ 371 Date: Mar. 7, 2023

(30) Foreign Application Priority Data
Sep. 8, 2020 (IN) 202011038721

(51) Int. Cl. C09D 125/06; C09D 5/16; C09D 7/62; C08K 3/04

(52) U.S. Cl. CPC C09D 125/06; C09D 5/1618; C08K 2003/321; C08K 3/041; C09D 7/62

(57) ABSTRACT

The control over the wettability of any surface fundamentally determines its interaction with water. In this regard, artificial surfaces with high water repellency has been of particular interest. The present invention relates to the synthesis and applications of a ceramic composite comprising phosphates of the lanthanide/rare earth series and organic phosphonic acids leading to superhydrophobic materials that offer non-wetting, multi-substrate compatible, additive compatible and antibacterial coatings with high water contact angles >150°.

### FIELD OF THE INVENTION

The present invention relates to synthesis and applications of a composite comprising phosphates of the lanthanide/rare earth series and organic phosphonic acids leading to superhydrophobic materials that offer non-wetting, multi-substrate compatible, additive compatible and antibacterial coatings with high water contact angles >150°.

### BACKGROUND AND PRIOR ART OF THE INVENTION

The control over the wettability of any surface fundamentally determines its interaction with water. Since the earth is often referred to as ‘Planet Water’, a technology that could possibly control the hydrophobicity/hydrophilicity of surfaces has AN unprecedented potential to literally change this ‘water world’ (J. T Simpson, S. R. Hunter and T. Aytug, Rep. Prog. Phys. 2015, 78, 086501). In this regard, artificial surfaces with high water repellency has been of particular interest (J. T Simpson, S. R. Hunter and T. Aytug, Rep. Prog. Phys. 2015, 78, 086501; G. Wen, Z. Guo and W. Liu, Nanoscale 2017, 9, 3338-3366; Q. Wen, Z. Guo, Chem. Lett. 2016, 45, 1134-1149; X.-M Li, D. Reinhoudt, and M. Crego-Calama Chem. Soc. Rev. 2007, 36, 1350-1368). A combination of the right surface chemistry and appropriate surface roughness has been utilized to design superhydrophobic surfaces for various applications. (X. Zhang, F. Shi, J. Niu, Y. Jiang and Z. Wang, J. Mat. Chem. 2008, 18, 621-633; A. J. Meuler, G. H. McKinley and R. E. Cohen, ACS Nano 2010, 4, 7048-7052; Y. Si and Z. Guo, Nanoscale 2015, 7, 5922-5946; M. Agrawal, S. Gupta and M. Stamm, J. Mat. Chem. 2011, 21, 615-627). Research pertaining to hierarchical structural features with well-defined topographic nanoscale architectures in combination with low surface energy materials have demonstrated the scope and applicability of hydrophobic and superhydrophobic surfaces in the laboratory scale (A. J. Meuler, G. H. McKinley and R. E. Cohen, ACS Nano 2010, 4, 7048-7052; C. Yang, U. Tartaglino, and B. N. J. Persson, Phys. Rev. Lett. 2006, 97, 116103; M. Nosonovsky, and B. Bhushan, J. Phys.: Condens. Matter. 2008, 20, 225009; S. Alexander, J. Eastoe, A. M. Lord, F. Guittard and A. R. Barron, ACS Appl. Mater. Interfaces 2016, 8, 660-666; H. Mertaniemi, A. Laukkanen, J. E. Teirfolk, O. Ikkala and R. H. A. Ras, RSC Adv. 2012, 2, 2882-2886). Superhydrophobic materials in terms of their self-cleaning, anti-corrosion, anti-icing, and anti-fouling applications and oil-water separation have been extensively investigated (J. Zhu, C.-M. Hsu, Z. Yu, S. Fan and Y. Cui, Nano Lett. 2010, 10, 1979-1984; S. J. Choi, and S. Y. Huh, Macromol. Rapid Commun. 2010, 31, 539-544; A. Nakajima, K. Hashimoto and T. Watanabe, Langmuir 2000, 16, 7044-7047; B. Bhushan, Y. C. Jung and K. Koch, Langmuir 2009, 25, 3240-3248; E. Vazirinasab, R. Jafari and G. Momen, Surface & Coatings Technology 2018, 341, 40-56; G. Momen and M. Farzaneh, Appl. Surf Sci. 2014, 299, 41-46; R. Jafari, R. Menini and M. Farzaneh, Appl. Surf Sci. 2010, 257, 1540-1543; J.-L. Wang, K.-F. Ren, H. Chang, S.-M. Zhang, L.-J. Jin and J. Ji, Phys. Chem. Chem. Phys. 2014, 16, 2936-2943; C. R. Crick, J. A. Gibbins and I. P. Parkin, J. Mat. Chem. A 2013, 1, 5943-5948; K. Li, X. Zeng, H. Lia and X. Lai, RSC Adv. 2014, 4, 23861-23868; Z. Chu, Y. Feng and S. Seeger, Angew. Chem. Int. Ed. 2015, 54, 2328-2338; J. Zhang, W. Huang and Y. Han, Macromol. Rapid Commun. 2006, 27, 804-808; C.-W. Tu, C.-H. Tsai, C.-F. Wang, S.-W. Kuo and F.-C. Chang, Macromol. Rapid Commun. 2007, 28, 2262-2266; A. K. Kota, G. Kwon, W. Choi, J. M. Mabry and A. Tuteja, Nature Commun. 2012, 3, 1025; L. Hu, S. Gao, X. Ding, D. Wang, J. Jiang, J. Jin and L. Jiang, ACS Nano 2015, 9, 4835-4842; C.-H. Xue, S.-T. Jia, J. Zhang and J.-Z. Ma, Sci Technol Adv Mater. 2010, 11, 033002).

Several methods have been used to prepare superhydrophobic surfaces including lithography, plasma techniques, electrochemical methods, chemical vapor deposition, etc. (T. M. Henderson (Ed.), Superhydrophobic Surfaces and Coatings: Investigations and Insights, 2017, Nova Science Publishers, Inc. USA; D. Öner and T. J. McCarthy, Langmuir 2000, 16, 7777-7782; T. Nakanishi, T. Michinobu, K. Yoshida, N. Shirahata, K. Ariga, H. Möhwald and D. G. Kurth, Adv.Mater. 2008, 20, 443-446; Y. Jiang, P. Wan, M. Smet, Z. Wang and X. Zhang, Adv. Mater. 2008, 20, 1972-1977; X. Zhang, F. Shi, X. Yu, H. Liu, Y. Fu, Z. Wang, L. Jiang and X. Li, J. Am. Chem. Soc. 2004, 126, 3064-3065; J. T. Han, D. H. Lee, C. Y. Ryu and K. Cho, J. Am. Chem. Soc. 2004, 126, 4796-4797). However, the application of these strategies, especially with reference to large area coatings, are limited by the size, type and geometry of these substrates.

Several patents have educated the development of superhydrophobic materials, formulations and coatings. U.S. Pat. No. 9,675,994 B2 (Schoenfisch, et al.) has disclosed the use of a fluorinated particle with methyl trimethoxysilane and a fluorinated alkane for the realization of superhydrophobic coatings. US 20180044541 (Jian, et al.) described a non-fluorinated composition including a hydrophobic polyolefin polymer free of fluorine, titanium dioxide nanoparticles as filler, and water on specified substrates as water repelling coatings. A super hydrophobic coating comprising of hydrophobic nano-particles of silsesquioxanes containing adhesion promoter group and a low surface energy group has been disclosed in U.S. Publication 2011/0177252 (Kanagasbapathy et al.). EP2951252A1 (Sunder, et al.) described a superhydrophobic coating with a built in lotus leaf effect for application on multiple substrates, comprising of organically modified nano particles of silica or titanium and polyurethane. U.S. Publication 2011/0206925 (Kissel et al.) described a three-step generated polymer aero-gel based hydrophobic coating, which upon annealing at 150° C. gave a contact angle of 140°. Ajayaghosh et al. in International Application No. PCT/IN08/00538, and U.S. application Ser. No. 12/678,546 have disclosed the use of Carbon allotropes based hybrid materials with functional organic molecules as superhydrophobic materials (T. Nakanishi, T. Michinobu, K. Yoshida, N. Shirahata, K. Ariga, H. Möhwald and D. G. Kurth, Adv. Mater. 2008, 20, 443-446; Z. Han, B. Tay, C. Tan, M. Shakerzadeh and K. Ostrikov, ACS Nano 2009, 3, 3031-3036; S. C. Tan, F. Yan, L. I. Crouch, J. Robertson, M. R. Jones and M. E. Welland, Adv. Funct. Mater. 2013, 23, 5556-5563; L. H. Li, Y. Y. Bai, L. L. Li, S. Q. Wang and T. Zhang, Adv. Mater. 2017, 29, 1702517; Y. Lin, G. J. Ehlert, C. Bukowsky and H. A. Sodano, ACS Appl. Mater. Interfaces 2011, 3, 2200-2203). Several patents and reports on use of oxides of metals such as, but not limited to, Silicon, Titanium, Zinc, Manganese, Aluminium, and Zirconium as well as nanoparticles of metals such as, but not limited to, gold, silver and palladium for imparting anti-wetting properties to surfaces are found.

CN 108976995 (Zang) teaches a procedure to use lanthanum phosphate/water based paint for a wicker product. Pristine lanthanum phosphate has not yet been shown to possess any inherent superhydrophobicity. Rare earth phosphate based non-reactive and non-wettable surfaces was described in EP3197829A2 (Sasidharan, et al.), however, this invention was limited to hydrophobicity alone and water contact angles in the order of 100° were obtained, particularly on reactive surfaces for molten metals like zinc and aluminium for applications in metal casting industry (S. Sasidharan B. N. Nair, T. Suzuki, G. M. Anilkumar, M. Padmanabhan, U. S. Hareesh and K. G. Warrier, Sci Rep 2016, 6, 22732). Multifunctional superhydrophobic properties with water contact angles >100°, compatible with multiple substrates have been rarely achieved with these classes of materials.

Therefore, there is a need in the art for composites having superhydrophobic properties with water contact angles >100° which are compatible with multiple substrates.

### OBJECTIVES OF THE INVENTION

The main objective of the present invention is to provide a composite material comprising phosphate salts of rare earth metals selected from lanthanum or cerium and an organic phosphonic acid.

Another objective of the present invention is to provide a water repellent surface having the water contact angles >150° on multiple substrates.

Yet another objective of the present invention is to provide a water repellent surface such that the surfaces are emissive upon light irradiation or electrically conducting via the controlled addition of selected additives, without loss of water contact angles >150°.

Still another objective of the present invention is to provide a composite material having an icephobic and antibacterial activity such that the surfaces contacted or coated with the composite material provides access to an antibacterial surface with negligible ice build-up, while water contact angles are retained >150°.

### SUMMARY OF THE INVENTION

An aspect of the present invention provides a composite comprising a phosphate salt of an element selected from lanthanide series and an organic phosphonic acid,
wherein the phosphate salt is a phosphate salt of Lanthanum or Cerium or mixture thereof and the organic phosphonic acid is selected from the group consisting of alkyl, allyl and aryl phosphonic acids,
   wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, said aryl groups is optionally substituted with halogen, OH, —CN, OR₁₋₃₀, NH₁₋₂R₀₋₃₀, N(R₁₋₃₀)₂, COOH, COOR₁₋₃₀, wherein R is a C₁₋₃₀ alkyl group;
wherein the phosphate salt of an element and the organic phosphonic acid is in a ratio in the range of 20:1 to 4:1 (w/w).

Another aspect of the present invention provides a process for preparing the composite, said method comprising
(a) activating a phosphate salt of an element selected from lanthanide series by acid treatment to obtain an activated phosphate salt;
(b) mixing the activated phosphate salt obtained in step (a) with an organic phosphonic acid in a ratio in the range of 20:1 to 4:1 (w/w) in an organic solvent to obtain a mixture;
(c) stirring the mixture obtained in step (b) at 25-28° C. for 72 hours followed by centrifugation at 5000 rpm for 10 min twice and drying for 12 hours at 70° C. in hot air oven to obtain the composite.

In an aspect of the present invention, there is provided a process for preparing the composite, wherein the acid treatment of the phosphate salt of an element is carried out by steps comprising of:
i. adding a mineral acid and the phosphate salt of an element in water and refluxing at 110° C. for 12 hours to obtain a suspension;
ii. cooling the suspension to room temperature and centrifuging at 5000 rpm for 10 minutes;
iii. redispersing in water and centrifuging at 5000 rpm for 10 minutes twice;
iv. redispersing in alcohol and centrifuging at 5000 rpm for 10 minutes to obtain a solid powder; and
v. drying the solid powder for 12 hours at 70° C. in a hot air oven to obtain the activated phosphate salt of an element.

In another aspect of the present invention, there is provided a process for preparing the composite, wherein the element from lanthanide series is selected from Lanthanum or Cerium.

In yet another aspect of the present invention, there is provided a process for preparing the composite, wherein the organic phosphonic acid is selected from the group consisting of alkyl, allyl and aryl phosphonic acids,
wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, said aryl groups is optionally substituted with halogen, OH, —CN, OR₁₋₃₀, NH₁₋₂R₀₋₃₀, N(R₁₋₃₀)₂, COOH, COOR₁₋₃₀, wherein R is a C₁₋₃₀ alkyl group.

In still another aspect of the present invention, there is provided a process for preparing the composite, wherein the organic solvent is selected from the group consisting of tetrahydrofuran, methanol, ethanol, propanol, isopropanol, pentane, hexane, heptane, octane, decane, cyclohexane, benzene, toluene, acetonitrile, and ether.

In another aspect of the present invention, there is provided a process for preparing the composite, wherein the mineral acid is orthophosphoric acid and the alcohol is selected from propanol or iso-propanol.

Yet another aspect of the present invention provides a composition comprising the composite and an organic solvent, wherein the organic solvent is selected from the group consisting of methanol, ethanol, propanol, isopropanol, pentane, hexane, heptane, octane, decane, cyclohexane, benzene, toluene, acetonitrile, ether, and tetrahydrofuran.

In another aspect of the present invention, there is provided a composition, wherein the composition optionally comprises a binder selected from polystyrene.

In still another aspect of the present invention, there is provided a composition, wherein the composition optionally comprises a colouring agent selected from dye or ink.

In yet another aspect of the present invention, there is provided a composition, wherein the composition optionally comprises a conductive additive selected from multi-walled carbon nanotubes.

Still another aspect of the present invention provides a water repellent surface comprising a substrate coated with the composition, wherein the substrate is selected from the group consisting of glass, wood, plastic, metal, cloth and paper.

### BRIEF DESCRIPTION OF THE DRAWINGS

FIG. 1 illustrates the X-ray Photoelectron Spectrum of the composite comprising of activated LaPO₄ and octadecyl phosphonic acid (4:1, w/w).

FIG. 2 illustrates the thermogravimetric data of the composite comprising of activated LaPO₄ and octadecyl phosphonic acid (4:1, w/w, solid line) and activated LaPO₄ (dashed line).

FIG. 3 illustrates the TEM images showing the nanorod like morphologies of pristine LaPO₄ (left), activated LaPO₄ (middle) and LaPO₄— octadecyl phosphonic acid composite (right).

FIG. 4 illustrates the water contact angle (˜134°) of the composite comprising of activated LaPO₄ and octyl phosphonic acid (4:1, w/w) on a cleaned glass substrate, without annealing.

FIG. 5 illustrates the water contact angle (˜140°) of the composite comprising of activated LaPO₄ and octyl phosphonic acid (4:1, w/w) on a cleaned glass substrate, annealed at 60° C. for 2 h.

FIG. 6 illustrates the water contact angle (˜143°) of the composite comprising of activated LaPO₄ and tetradecyl phosphonic acid (4:1, w/w) on a cleaned glass substrate, without annealing.

FIG. 7 illustrates the water contact angle (˜145°) of the composite comprising of activated LaPO₄ and tetradecyl phosphonic acid (4:1, w/w) on a cleaned glass substrate, annealed at 60° C. for 2 h.

FIG. 8 illustrates the water contact angle (˜152°) of the composite comprising of activated LaPO₄ and octadecyl phosphonic acid (4:1, w/w) on a cleaned glass substrate, without annealing.

FIG. 9 illustrates the water contact angle (˜156°) of the composite comprising of activated LaPO₄ and octadecyl phosphonic acid (4:1, w/w) on a cleaned glass substrate, annealed at 60° C. for 2 h.

FIG. 10 illustrates the photographs of water droplets on a glass substrate coated with the composite comprising of activated LaPO₄ and octadecyl phosphonic acid (4:1, w/w), annealed at 60° C. for 2 h. Colored water is used for clarity

FIG. 11 illustrates the large area coatings (7.5 cm×11 cm): (A) water contact angle (˜153°) and photographs of (B) the slide and (C) water droplets on a glass substrate coated a composite of activated LaPO₄ and octadecyl phosphonic acid (4:1, w/w), annealed at 60° C. for 2 h.

FIG. 12 illustrates the water contact angle (˜153°) of the composite comprising of activated LaPO₄, octadecyl phosphonic acid (4:1, w/w) and 5% polystyrene on a cleaned glass substrate, annealed at 60° C. for 2 h.

FIG. 13 illustrates the water contact angle (˜154°) of the composite comprising of activated LaPO₄ and octadecyl phosphonic acid (4:1, w/w) fixed on a cleaned glass substrate using a PDMS glue, and cured at 80° C. for 2 h.

FIG. 14 illustrates the water contact angle of the composite comprising of activated LaPO₄ and octadecyl phosphonic acid (4:1, w/w) fixed on different substrates using a PDMS glue, and cured at 80° C. for 2 h.

FIG. 15 illustrates the photographs of water droplets on different substrates coated a composite of activated LaPO₄ and octadecyl phosphonic acid (4:1, w/w) fixed on the substrates using a PDMS glue, and cured at 80° C. for 2 h.

FIG. 16 illustrates the changes in water contact angles of the composite comprising of activated LaPO₄ and octadecyl phosphonic acid (4:1, w/w) fixed on a cleaned glass substrate using a PDMS glue, and cured at 80° C. for 2 h after 5 cycles of scotch tape tests, confirming the stability.

FIG. 17 illustrates the stability and durability of the composite coating comprising of activated LaPO₄ and octadecyl phosphonic acid (4:1, w/w) fixed on a wooden substrate using a PDMS glue, and cured at 80° C. for 2 h after 90 days of exposure to ambient environmental conditions, with water contact angles ˜154°.

FIG. 18 illustrates the photograph (left) of water droplets and the corresponding water contact angle (right, ˜155°) of a glass substrate coated with the composite comprising of activated LaPO₄, octadecyl phosphonic acid (4:1, w/w), and a green colorant, annealed at 60° C. for 2 h.

FIG. 19 illustrates the photograph (left) of water droplets and the corresponding water contact angle (right, ˜153°) of a glass substrate coated with the composite comprising of activated LaPO₄, octadecyl phosphonic acid (4:1, w/w), and a blue colorant, annealed at 60° C. for 2 h.

FIG. 20 illustrates the photographs under daylight (top) and under UV light (365 nm, bottom) of a glass substrate coated with the composite comprising of activated LaPO₄, octadecyl phosphonic acid (4:1, w/w, left), and a cyan emitting superhydrophobic coating obtained via the addition of pyrene to the composite (1:10 w/w), both annealed at 60° C. for 2 h.

FIG. 21 illustrates the photograph under UV-light (365 nm, left) of water droplets on a cyan emitting superhydrophobic coating and the corresponding water contact angle (right, ˜153°) of a glass substrate coated with the composite comprising of activated LaPO₄, octadecyl phosphonic acid (4:1, w/w), containing an additive (pyrene, 1:10 w/w as the composite), annealed at 60° C. for 2 h.

FIG. 22 illustrates the photographs of a glass substrate coated with the composite comprising of activated LaPO₄, octadecyl phosphonic acid (4:1, w/w, left), and a conducting superhydrophobic coating obtained via the addition of MWCNTs to the composite (1:4 w/w), both annealed at 60° C. for 2 h.

FIG. 23 illustrates the photograph of water droplets on a conductive superhydrophobic coating and the corresponding water contact angle (right, ˜157°) of a glass substrate coated with the composite comprising of activated LaPO₄, octadecyl phosphonic acid (4:1, w/w), containing an additive (MWCNT, 1:4 w/w as the composite), annealed at 60° C. for 2 h.

FIG. 24 illustrates Current Vs Voltage plots for a conductive superhydrophobic coating on a glass substrate using the composite comprising of activated LaPO₄, octadecyl phosphonic acid (4:1, w/w), containing an additive (MWCNT, 1:4 w/w as the composite), annealed at 60° C. for 2 h. Estimated Conductivity=1.24 S/cm

FIG. 25 illustrates slippery superhydrophobicity of the LaPO₄-cotadecyl phosphonic acid composite coating on a metal substrate. Stage 1 shows the water drop just before impact, Stage 2 shows the water drop upon impact, Stages 3-8 represent the bouncing and roll-off, Stages 9-10 illustrate the sticky nature of the uncoated portion of the substrate, corroborating the icephobic properties of the coating. The line represents the point of initial impact.

FIG. 26 illustrates the table showing the antibacterial performance of the LaPO₄-cotadecyl phosphonic acid composite and the photographs (control: left and actual samples: right) showing the antibacterial activity on E. Coli (>90% inhibition), 4 h incubation time.

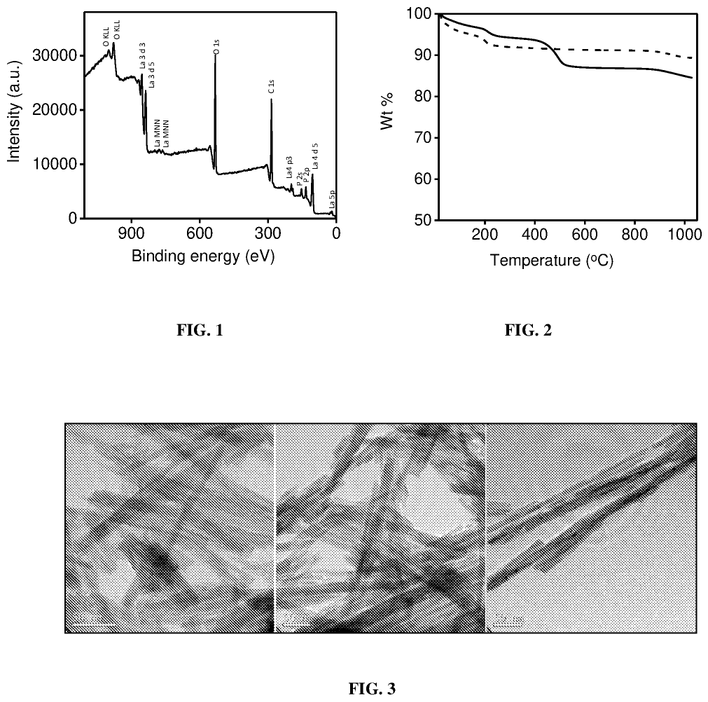

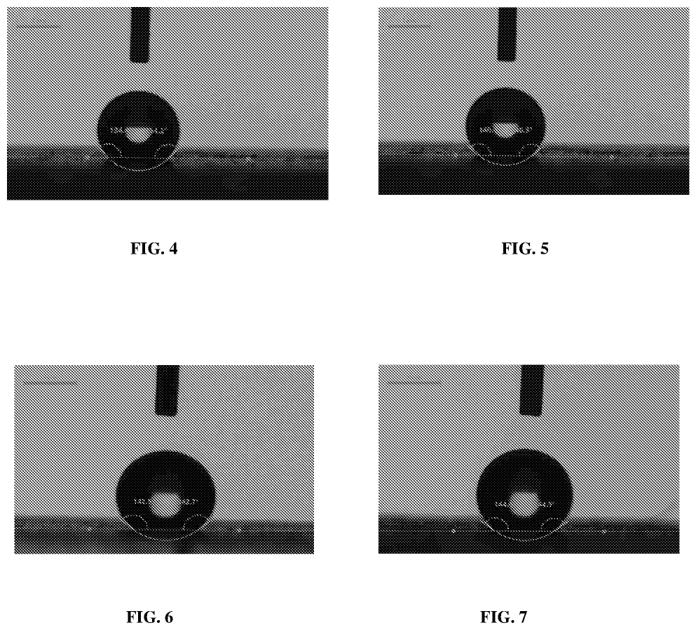

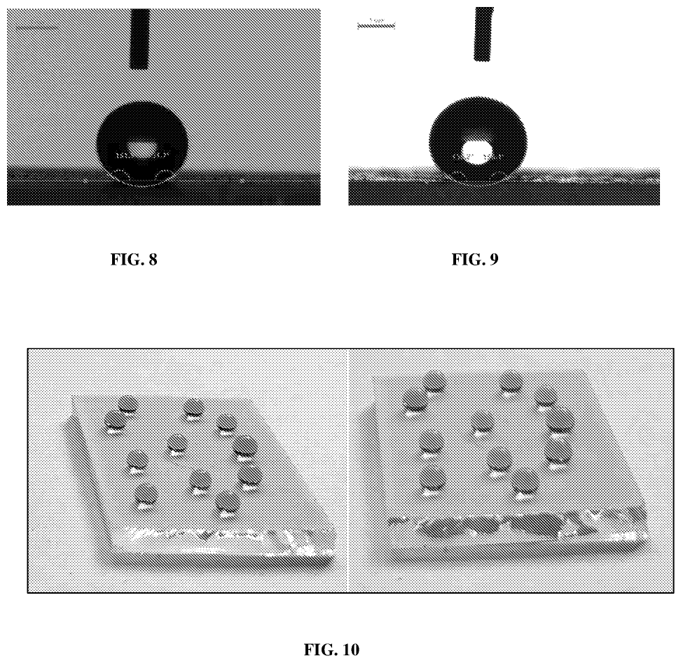

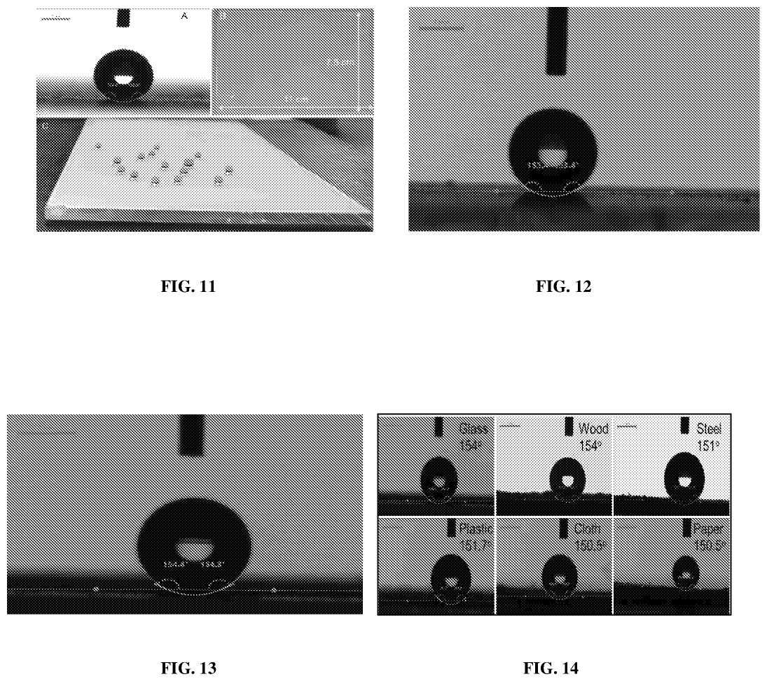

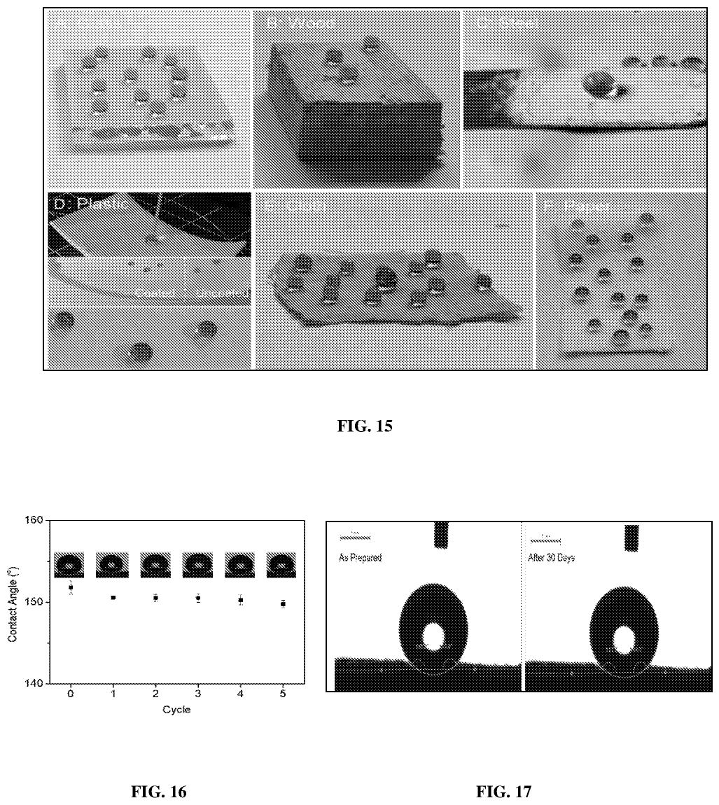

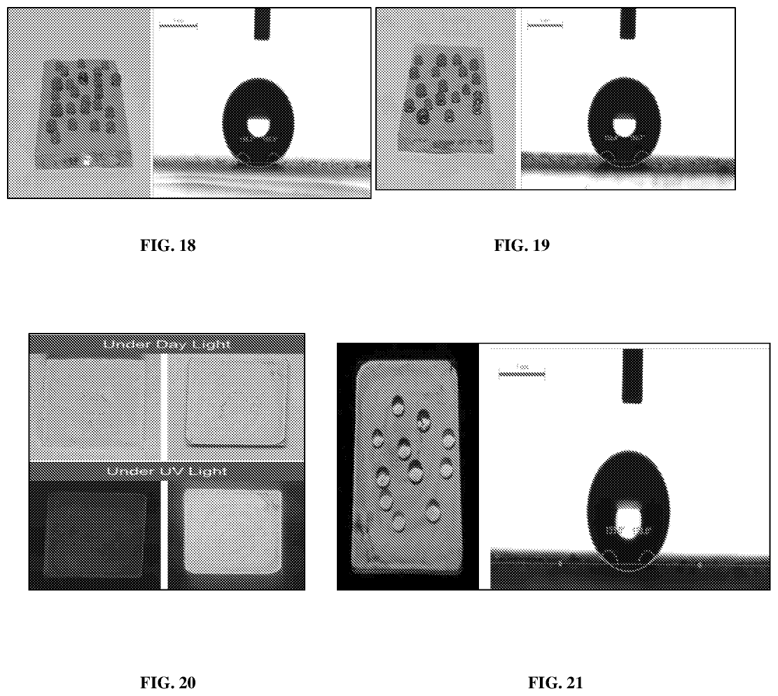

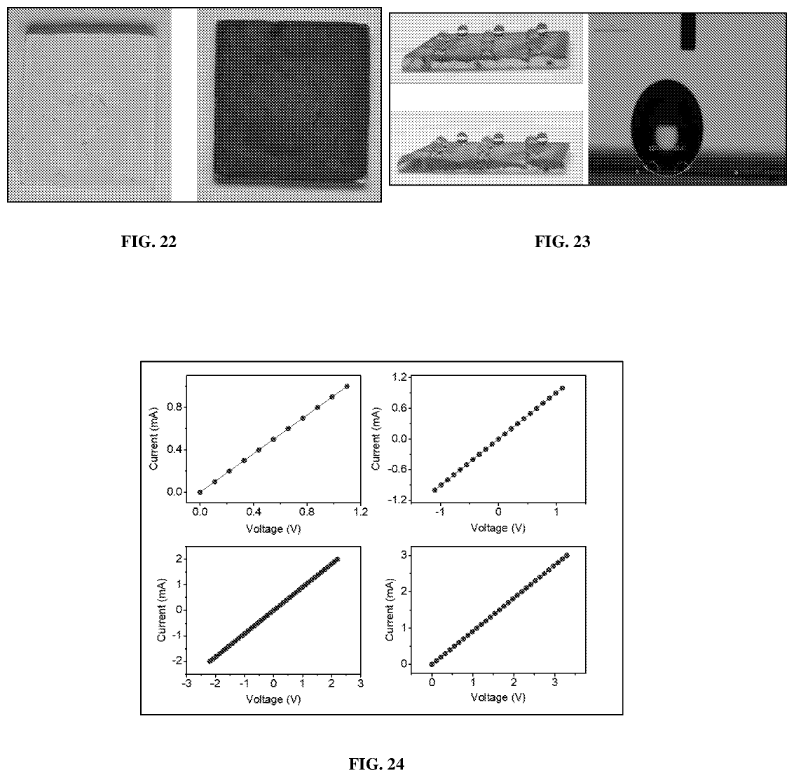

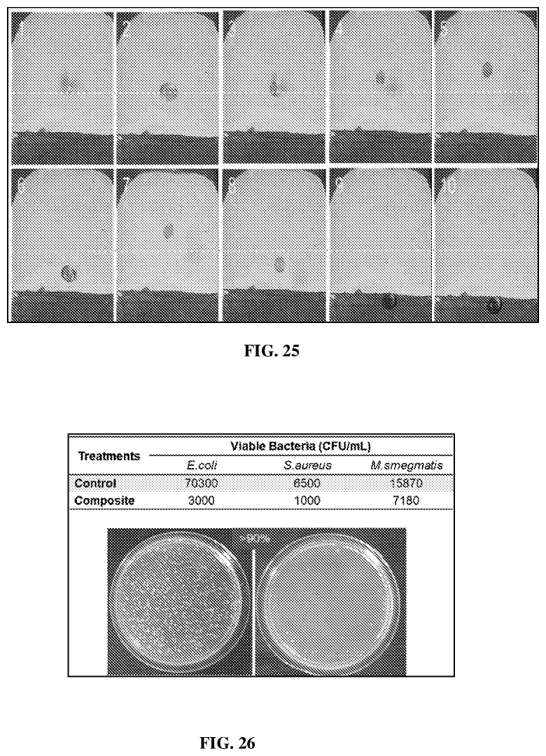

### ABBREVIATIONS USED

PDMS: polydimethyl siloxane
wt %: weight percentage
cm: centimeter
nm: nanometer
MWCNT: multi walled carbon nanotubes
S/cm: Siemens per centimeter
Rpm: rotations per minute
mg: milligrams
mL: milliliter

### DETAILED DESCRIPTION OF THE INVENTION

This section describes the present invention in preferred embodiments in detail.

The present invention is directed towards a composite comprising a phosphate salt of an element selected from lanthanide series and an organic phosphonic acid,
wherein the phosphate salt is a phosphate salt of Lanthanum or Cerium or mixture thereof and the organic phosphonic acid is selected from the group consisting of alkyl, allyl and aryl phosphonic acids,
   wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, said aryl groups is optionally substituted with halogen, OH, —CN, OR₁₋₃₀, NH₁₋₂R₀₋₃₀, N(R₁₋₃₀)₂, COOH, COOR₁₋₃₀, wherein R is a C₁₋₃₀ alkyl group;
wherein the phosphate salt of an element and the organic phosphonic acid is in a ratio in the range of 20:1 to 4:1 (w/w).

In an embodiment of the present invention, there is provided a composite comprising a phosphate salt of an element selected from lanthanide series and an organic phosphonic acid, wherein the phosphate salt of an element and the organic phosphonic acid is in a ratio in the range of 10:1 (w/w).

In another embodiment of the present invention, there is provided a composite comprising a phosphate salt of an element selected from lanthanide series and an organic phosphonic acid, wherein the phosphate salt of an element and the organic phosphonic acid is in a ratio in the range of 4:1 (w/w).

The present invention is also directed towards a process for preparing the composite, said method comprising
(a) activating a phosphate salt of an element selected from lanthanide series by acid treatment to obtain an activated phosphate salt;
(b) mixing the activated phosphate salt obtained in step (a) with an organic phosphonic acid in a ratio in the range of 20:1 to 4:1 (w/w) in an organic solvent to obtain a mixture;
(c) stirring the mixture obtained in step (b) at 25-28° C. for 72 hours followed by centrifugation at 5000 rpm for 10 min twice and drying for 12 hours at 70° C. in hot air oven to obtain the composite.

In an embodiment of the present invention, there is provided a process for preparing the composite, wherein the acid treatment of the phosphate salt of an element is carried out by steps comprising of:
i. adding a mineral acid and the phosphate salt of an element in water and refluxing at 110° C. for 12 hours to obtain a suspension;
ii. cooling the suspension to room temperature and centrifuging at 5000 rpm for 10 minutes;
iii. redispersing in water and centrifuging at 5000 rpm for 10 minutes twice;
iv. redispersing in alcohol and centrifuging at 5000 rpm for 10 minutes to obtain a solid powder; and
v. drying the solid powder for 12 hours at 70° C. in a hot air oven to obtain the activated phosphate salt of an element.

In another embodiment of the present invention, there is provided a process for preparing the composite, wherein the element from lanthanide series is selected from Lanthanum or Cerium.

In yet another embodiment of the present invention, there is provided a process for preparing the composite, wherein the organic phosphonic acid is selected from the group consisting of alkyl, allyl and aryl phosphonic acids,
wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, said aryl groups is optionally substituted with halogen, OH, —CN, OR₁₋₃₀, NH₁₋₂R₀₋₃₀, N(R₁₋₃₀)₂, COOH, COOR₁₋₃₀ wherein R is a C₁₋₃₀ alkyl group.

In still another embodiment of the present invention, there is provided a process for preparing the composite, wherein the organic solvent is selected from the group consisting of tetrahydrofuran, methanol, ethanol, propanol, isopropanol, pentane, hexane, heptane, octane, decane, cyclohexane, benzene, toluene, acetonitrile, and ether.

In an embodiment of the present invention, there is provided a process for preparing the composite, wherein the mineral acid is orthophosphoric acid and the alcohol is selected from propanol or iso-propanol.

An embodiment of the present invention provides a composition comprising the composite and an organic solvent, wherein the organic solvent is selected from the group consisting of methanol, ethanol, propanol, isopropanol, pentane, hexane, heptane, octane, decane, cyclohexane, benzene, toluene, acetonitrile, ether, and tetrahydrofuran.

In an embodiment of the present invention there is provided a composition comprising the composite and an organic solvent, wherein the composition optionally comprises a binder selected from polystyrene and the ratio of binder to composite is 1:20 (w/w).

In another embodiment of the present invention there is provided a composition comprising the composite and an organic solvent, wherein the composition optionally comprises a colouring agent selected from dye or ink.

In yet another embodiment of the present invention there is provided a composition comprising the composite and an organic solvent, wherein the composition optionally comprises a conductive additive selected from multi-walled carbon nanotubes and the ratio of multi-walled carbon nanotubes to composite is in the range of 1:25 to 1:10 (w/w).

In still another embodiment of the present invention there is provided a composition comprising the composite and an organic solvent, wherein the composition optionally comprises an organic or inorganic fluorescent additive and the ratio of fluorescent additive to composite is in the range of 1:50 to 1:10 (w/w).

Still another embodiment of the present invention provides a water repellent surface comprising a substrate coated with the composition, wherein the substrate is selected from the group consisting of glass, wood, plastic, metal, cloth and paper.

Upon extensive investigations related to water repellent coatings, the inventors of the present invention found that organically modifying the surface of ceramic materials, comprising phosphate salts of rare earth metals selected from lanthanum or cerium, having a defined nanoscopic morphology, and an organic phosphonic acid imparts unprecedentedly high water contact angles >1500 to the surfaces in contact or coated with the said composite material.

In one embodiment, the present invention is directed towards a method for preparation of a superhydrophobic ceramic composite via a two-step procedure comprising activation of a phosphate salt of a rare earth metal, preferably lanthanum and/or cerium phosphates or their mixtures at ratios between 1:10 and 10:1, and contacting the activated phosphate with an organic phosphonic acid. The phosphonic acid is independently selected from the group consisting of alkyl, allyl and aryl phosphonic acids. The preferred phosphate salt is lanthanum phosphate calcined at 200-250° C. with a defined nanoscopic morphology. The phosphate salt is activated via an acid treatment, using a mineral acid, selected from orthophosphoric acid. The mineral acid is at a concentration of 1 mL/25 mL water per gram of LnPO₄. The phosphate salt is treated with mineral acid at 110° C. for 12 h, cooled and centrifuged at 5000 rpm for 10 min, re-dispersed in water and centrifuged at 5000 rpm for 10 min (2×), followed by re-dispersion in alcohol and centrifuged at 5000 rpm for 10 min and dried for 12 h at 70° C. The alcohol used is propanol, more preferably iso-propanol.

The present invention is directed towards a composite, comprising LnPO₄ and organic phosphonic acids in a ratio less than 20:1, preferably 10:1, more preferably 4:1, wherein Ln is independently selected from La³⁺, and Ce³⁺, or a mixture thereof, with Ln/Ce ratios between 0:10 and 10:0, preferably LaPO₄ obtained from its precursors, which is calcined at 200-250° C. with a defined nanoscopic morphology. The phosphonic acid is independently selected from the group consisting of alkyl, allyl and aryl phosphonic acids, wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, said aryl groups is optionally substituted with halogen, OH, —CN, OR₁₋₃₀, NH₁₋₂R₀₋₃₀, N(R₁₋₃₀)₂, COOH, COOR₁₋₃₀, wherein R is a C₁₋₃₀ alkyl group.

The present invention is also directed towards a thin coating of said composite, fabricated from its dispersion in an organic solvent, wherein the non-limiting examples of the organic solvent include alcohols selected from the group consisting of methanol, ethanol, propanol, and isopropanol, hydrocarbon selected from the group consisting of pentane, hexane, heptane, octane, decane, cyclohexane, benzene, toluene, acetonitrile, ether, and tetrahydrofuran at a minimum composition of 1 wt % solvent up to a maximum composition of 99 wt % solvent. The weighted composition of the composite to the solvent is 50 mg/mL, preferably 30 mg/mL, more preferably 20 mg/mL, drop-cast or spin-cast on a solid substrate.

In certain embodiments, the solid substrate is comprised of an organic material (minimum 50% organic composition) such as, but not limited to polymers, fabric or paper, inorganic materials (minimum 50% organic composition) such as, but not limited to, metallic materials and alloys, and non-metallic materials such as, but not limited to carbon, semiconductors, glasses and ceramics, containing or devoid of oxides, nitrides, carbides, borides,—phosphates, sulfides, etc. In certain specific embodiments, said substrate is selected from the group consisting of glass, wood, plastic, metal, cloth and paper. When the substrate is contacted or coated with the composition comprising the composite material, dried and annealed at 60° C. for 2 h, it exhibits water repellence with a water contact angle >150°.

Another embodiment of the present invention comprises a spray, spin, dip or drop coatable formulation of the composite dispersed in a solvent, selected from tetrahydrofuran, comprising a binder, wherein said binder is polystyrene, preferably of molecular weight 35,000, at a ratio of 1:20 (binder: composite, w/w). Further, a stable film of the composite, is coated on a substrate selected from the group consisting of glass, wood, plastic, metal, cloth and paper, formed via a “powder-on-glue” technique, wherein the glue is a thin doctor-bladed film of polydimethyl siloxane (PDMS) containing a suitable curing agent at a weighted composition of 10:1 (w/w) and the powder is said composite fixed by the glue on to the substrate. The excess powder is removed by an aspirator, followed by curing at 80° C. for 3 h. These strategies lead to high water repellence with water contact angles in excess of 1500.

In specific embodiments, the invention relates to the stability and durability of said composite material and the contacted or coated substrates, wherein the stability and durability are expressed in terms of shelf-life of the composite or the modified substrate. Scotch-tape tests of the modified substrates, as well as exposure to environmental conditions, with preferably 80% performance retention, more preferably 90% performance retention for a week, preferably for a month, more preferably for a year have been conducted. The shelf-life of the composite and the coated substrates under laboratory conditions was estimated to be more than a year. 5 subsequent scotch-tape tests resulted in contact angles >150° and exposure to environmental conditions for more than a month retained >90% of the water repellence of the modified substrates.

Another embodiment of the present invention provides a method for reducing condensation or ice formation on the composite modified surfaces via slippery hydrophobic nature of the substrate induced by the composite. The substrates contacted or coated with the composite do not allow water droplets to stick, the coatings thus imparting anti-icing properties to the substrate leading to icephobic surfaces with a rolling angle less than 5°, preferably less than 3°, more preferably less than 2°, and the composite material, coating or formulation with high water repellence and water contact angles in excess of 150° on suitable substrates with a slippery superhydrophobicity.

In another embodiment of the present invention, a formulation of the composite in an organic solvent, wherein the non-limiting examples of solvent include alcohol selected from the group consisting of methanol, ethanol, propanol, isopropanol, hydrocarbons selected from the group consisting of pentane, hexane, heptane, octane, decane, cyclohexane, benzene, toluene, acetonitrile, ether, and tetrahydrofuran, preferably tetrahydrofuran containing suitable coloring agents, selected from inks or dyes soluble in tetrahydrofuran. of the formulation has 50:1 to 1:1 w/v of the composite to the solvent, preferably 20 mg composite in 1 mL tetrahydrofuran containing 0.1-2.0 mg of the coloring agent, preferably 0.5-1.0 mg of the coloring agent, to yield a colored superhydrophobic non-wetting surface thereof, without the loss of water contact angles >150°.

Another aspect of the present invention is directed towards the induced multifunctional characteristics including, but not limited to, non-wettable light emitting fluorescent coatings via the controlled addition of an organic or inorganic fluorescent additive at a weighted composition of 1:50 (w/w) as the LaPO₄ composite, preferably at a weighted composition of 1:25 (w/w), more preferably at a weighted composition of 1:10 (w/w), as well as the controlled addition of a conducting additive, preferably a conducting allotrope of carbon, more preferably multi-walled carbon nanotubes (MWCNTs) of diameter >100 nm, at a weighted composition of 1:25 (w/w) as the LaPO₄ composite, preferably at a weighted composition of 1:10 (w/w), more preferably at a weighted composition of 1:4 (w/w), the said coating with conductivities >1.2 S/cm, the said coating without MWCNTs having conductivities <10⁻⁹ S/cm, thereby inducing a minimum of 10⁹ fold increase in conductivity of the non-wettable conducting surface, the coating in each of the above with no detectable variations in its wettability profile as measured by the water contact angle values >150′.

In particular, such embodiments where the composite material, formulations and coatings, with slippery superhydrophobicity, icephobic, anti-wetting and broad spectrum antibacterial action against common pathogenic bacteria leads to reduction in microbial adhesion and survival by 70%, preferably by 80% and more preferably by 90%, the microbes selected from both grams positive and gram negative strains. In certain specific embodiments, the bacterial strains are selected from Escherichia coli (E. coli) Mycobacterium smegmatis (M.smegmatis) or Staphylococcus aureus (S.aureus). However, addition of a functional biocide component, preferably up to 5 wt %, can tune the antimicrobial activity of the material or coating towards partial inhibition, prevention, reduction or elimination of the growth and coverage of one or more undesirable organisms including, but not limited to bacteria, fungi, virus, insects, etc., that are in the close proximity of the coated surface or come in contact with it.

### EXAMPLES

The following examples are offered by way of illustration and not by way of limitation.

### Example 1. Activation of the Phosphate Salt of Rare Earth Metals

LnPO₄ (Ln is independently selected from La³⁺, and Ce³⁺ or a mixture of Ln³⁺ and Ce³⁺, with any Ln/Ce ratios between 0:10 and 10:0), preferably LaPO₄ calcined at 200-250° C., was surface-activated by an acid treatment procedure. A mineral acid, preferably orthophosphoric acid, in water at a concentration of 1 mL/25 mL water per gram of LnPO₄ was added and refluxed at 110° C. for 12 h. The suspension was then cooled to room temperature and centrifuged at 5000 rpm for 10 min, redispersed in water and centrifuged at 5000 rpm for 10 min (2×), followed by re-dispersion in alcohol, preferably propanol and centrifuged at 5000 rpm for 10 min. The solid powder thus obtained was dried for 12 h at 70° C. in a hot air oven.

### Example 2. Synthesis of LaPO₄—Alkyl/Cycloalkyl/Allyl Phosphonic Acid Composite

Activated LaPO₄, with a defined rod-like morphology and corresponding alkyl phosphonic acid in a 4:1 (w/w) ratio were mixed in in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc.

### Example 2.1. Synthesis of LaPO₄—Hexyl Phosphonic Acid Composite

Activated LaPO₄, with a defined rod-like morphology and hexyl phosphonic acid in a 4:1 (w/w) ratio were mixed in in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.2. Synthesis of LaPO₄—Octyl Phosphonic Acid Composite

Activated LaPO₄, with a defined rod-like morphology and octyl phosphonic acid in a 4:1 (w/w) ratio were mixed in in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.3. Synthesis of LaPO₄—Decyl Phosphonic Acid Composite

Activated LaPO₄, with a defined rod-like morphology and decyl phosphonic acid in a 4:1 (w/w) ratio were mixed in in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.4. Synthesis of LaPO₄—Dodecyl Phosphonic Acid Composite

Activated LaPO₄, with a defined rod-like morphology and dodecyl phosphonic acid in a 4:1 (w/w) ratio were mixed in in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.5. Synthesis of LaPO₄—Tetradecyl Phosphonic Acid Composite

Activated LaPO₄, with a defined rod-like morphology and tetradecyl phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.6. Synthesis of LaPO₄—Octadecyl Phosphonic Acid Composite

Activated LaPO₄, with a defined rod-like morphology and octyl phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.7. Synthesis of LaPO₄—Cyclohexyl Phosphonic Acid Composite

Activated LaPO₄, with a defined rod-like morphology and cyclohexyl phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 2.8. Synthesis of LaPO₄—Allyl Phosphonic Acid Composite

Activated LaPO₄, with a defined rod-like morphology and allyl phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 3. Synthesis of LaPO₄—Aryl Phosphonic Acid Composite

Activated LaPO₄, with a defined rod-like morphology and corresponding aryl phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc.

### Example 3.1. Synthesis of LaPO₄—Phenyl Phosphonic Acid Composite

Activated LaPO₄, with a defined rod-like morphology and phenyl phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 3.2. Synthesis of LaPO₄—Benzyl Phosphonic Acid Composite

Activated LaPO₄, with a defined rod-like morphology and benzyl phosphonic acid in a 4:1 (w/w) ratio were mixed in an organic solvent, preferably tetrahydrofuran, to get a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 3.3. Synthesis of LaPO₄—p-(4-[2,2′:6′,2″-Terpyridin]-4′-ylphenyl) phosphonic acid Phosphonic Acid Composite

Activated LaPO₄, with a defined rod-like morphology and p-(4-[2,2′:6′,2″-Terpyridin]-4′-ylphenyl) phosphonic acid in a 4:1 (w/w) ratio were mixed in an organic solvent, preferably tetrahydrofuran, to obtain a final composition of 50 mg phosphonic acid per 200 mg activated LaPO₄ in 25 mL tetrahydrofuran. The mixture was stirred at 25-28° C. for 72 h, followed by centrifugation at 5000 rpm for 10 min (2×), and dried for 12 h at 70° C. in a hot air oven.

### Example 4. Synthesis of CePO4—Alkyl/CycloalkylAllyl Phosphonic Acid Composite

The experimental procedure elaborated in Example 3 was extended to other metal phosphates in the rare lanthanide series as follows: Activated CePO4+ corresponding alkyl phosphonic acid (4:1 w/w) in THF (final composition of 50 mg phosphonic acid per 200 mg activated CePO4 in 25 mL tetrahydrofuran), stirring at 25-28° C. for 72 h, followed by centrifugation at 5000 rpm for 10 min (2×), and drying for 12 h at 70° C. in a hot air oven.

### Example 5. Synthesis of Mixed LaPO₄—CePO4-Alkyl/Cycloalkyl/Ally/Aryl Phosphonic Acid Composite

The experimental procedure elaborated in Example 3 was extended to mixed metal phosphates in the rare lanthanide series as follows: Activated (mixed) LaPO₄—CePO4 in any ratio between 0:10 and 10:0+ corresponding alkyl phosphonic acid (4:1 w/w) in THF (final composition of 50 mg phosphonic acid per 200 mg activated (mixed) LaPO₄—CePO4 in 25 mL tetrahydrofuran), stirring at 25-28° C. for 72 h, followed by centrifugation at 5000 rpm for 10 min (2×), and drying for 12 h at 70° C. in a hot air oven.

### Example 6. Preparation of Thin Coatings of the Composite on Solid Substrates and Multi-Substrate Compatibility

LaPO₄-octadecyl phosphonic acid composite material (20 mg) was dispersed in an organic solvent, preferably tetrahydrofuran (1.0 mL), at a composition 20 mg/mL. The mixture was stirred overnight to obtain a stable dispersion. This dispersion was drop-cast or spin-cast on a substrate, selected independently from glass, wood, plastic, metal, cloth or paper, dried at room temperature and optionally annealed at 60° C. for 2 h to obtain the surface modified substrate exhibiting water repellence with a water contact angle >150°, confirming the substrate independent or multi-substrate compatible anti-wetting behavior.

Coatings on suitable substrates were also obtained using other phosphonic acids, following the exact same procedure as that for octadecyl phosphonic acid.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc.

### Example 7. Formulation of the Composite with Polystyrene Binder

A spray, spin, dip or drop coatable formulation of the composite was prepared using an organic solvent, preferably tetrahydrofuran. LaPO₄-octadecyl phosphonic acid composite material (20 mg) was dispersed in tetrahydrofuran (1.0 mL), at a composition 20 mg/mL. Polystyrene (1 mg, molecular weight 35,000) was added as a binder at a composition 1:20 (binder:composite, w/w) and stirred overnight at room temperature to obtain a stable dispersion. This dispersion was drop-cast or spin-cast on a substrate, selected independently from glass, wood, plastic, metal, cloth or paper, dried at room temperature and optionally annealed at 60° C. for 2 h to obtain the surface modified substrate exhibiting water repellence with a water contact angle >150°, confirming the substrate independent or multi-substrate compatible anti-wetting behavior.

Coatings on suitable substrates were also obtained using other phosphonic acids, following the exact same procedure as that for octadecyl phosphonic acid.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc.

### Example 8. Stable Film of the Composite Using “Powder-On-Glue” Technique

A stable film of LaPO₄-octadecyl phosphonic acid composite on a suitable substrate formed via a “powder-on-glue” technique. A thin doctor-bladed film of polydimethyl siloxane (PDMS) containing a suitable curing agent at a weighted composition of 10:1 (w/w) was used as the glue and the composite was used as the powder. In a typical procedure, a very thin film of PDMS and curing agent (100 μL) was placed on a glass substrate (2 cm×2 cm). A thin film of the PDMS glue was obtained via a doctor-blading technique. 20 mg of dried finer powder of LaPO₄-octadecyl phosphonic acid composite was sprinkled over the glue and excess powder was removed by an aspirator, followed by curing at 80° C. for 3 h to obtain a stable film of the composite on glass.

Substrate independence and multi-substrate compatibility was demonstrated using substrates selected independently from glass, wood, plastic, metal, cloth and paper.

### Example 9. Scotch Tape Tests for Stability Measurements and Ambient Durability of Coatings

A stable film of LaPO₄-octadecyl phosphonic acid composite on glass was formed via a “powder-on-glue” technique as explained in Example 9. The water contact angle of the modified substrate was experimentally determined. A commercially available scotch tape was pasted on to the coated substrate and was peeled off abruptly. The water contact angle of the resulting coating was measured. The scotch tape test was repeated 5 times and the water contact angles corresponding to these five scotch tape tests were subsequently determined. A water contact angle >150° was observed in every case corroborating the stability of the coatings.

The durability and shelf-life of the composite material was tested by comparing the water contact angles of glass substrates coated with the composite after a year of its preparation. A water contact angle >150° was observed, confirming a minimum of one year shelf-life of the composite material. A drop-cast glass slide, kept under laboratory conditions, was subjected to water contact angle measurements after a year of its fabrication. A water contact angle >150° confirmed the durability of the coating. A wodden substrate coated with the composite using the “powder-on-glue” technique was exposed to ambient environment for a few weeks and a water contact angle of ˜154° after four weeks further confirmed the durability of the coatings under ambient conditions.

### Example 10. Slippery Hydrophobicity and Icephobic Nature

A stable film of LaPO₄-octadecyl phosphonic acid composite on glass was formed via a “powder-on-glue” technique as explained in Example 9. The water contact angle of the modified substrate was experimentally determined. Reduced condensation or ice formation on the composite modified surfaces was established via the demonstration of slippery hydrophobic nature of the substrate. The composite coating did not allow water droplets to stick to the surface, allowing the water droplets to roll off at angles as low as 2° on metal substrates and 0° on wodden substrates. The modified substrate was further placed inside a commercial freezer for 12 h and no ice build-up was observed.

### Example 11. Preparation of Colored Coatings

A spray, spin, dip or drop coatable formulation of LaPO₄-octadecyl phosphonic acid composite was prepared using an organic solvent, preferably tetrahydrofuran. The composite material (20 mg) was dispersed in tetrahydrofuran (1.0 mL), at a concentration 20 mg/mL. A commercially available green or blue ink was added as a coloring agent (1.0 mg) and stirred overnight at room temperature to obtain a stable dispersion. This dispersion was drop-cast or spin-cast on a substrate, selected independently from glass, wood, plastic, metal, cloth or paper, dried at room temperature and optionally annealed at 60° C. for 2 h to obtain the surface modified substrate with a greenish or bluish color exhibiting water repellence with a water contact angle >150°, providing a colored superhydrophobic non-wetting surface.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc. Further, any dye of any color soluble in the solvent can be used to generate colored non-wetting coatings.

### Example 12. Preparation of Light Emitting Coatings

A spray, spin, dip or drop coatable formulation of LaPO₄-octadecyl phosphonic acid composite was prepared using an organic solvent, preferably tetrahydrofuran. The composite material (20 mg) was dispersed in tetrahydrofuran (1.0 mL), at a concentration 20 mg/mL. A commercially available fluorescent compound (pyrene in this case, 2.0 mg at a concentration of 1:10 w/w) was added and stirred overnight at room temperature to obtain a stable dispersion. This dispersion was drop-cast or spin-cast on a substrate, selected independently from glass, wood, plastic, metal, cloth or paper, dried at room temperature and optionally annealed at 60° C. for 2 h to obtain the surface modified substrate with a light emitting property (cyan emission in this case) under UV illumination (365 nm), exhibiting water repellence with a water contact angle >150°, providing an emissive superhydrophobic non-wetting surface.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc. Further, any fluorescent material, organic or inorganic, soluble in the solvent can be used to generate emissive non-wetting coatings.

### Example 13. Preparation of Conducting Coatings

A commercially available conducting additive (multi-walled carbon nanotubes (MWCNTs) of diameter >100 nm in this case, 5.0 mg) was dispersed in tetrahydrofuram (1.0 mL) via ultrasonication for 30 min. LaPO₄-octadecyl phosphonic acid composite (20 mg) was then added to this sonicated dispersion in tetrahydrofuran (1.0 mL) such that the final concentration is 20 mg/mL and 1:4 w/w of MWCNTs/composite. The mixture was stirred overnight at room temperature to obtain a stable dispersion. This dispersion was drop-cast or spin-cast on a substrate, selected independently from glass, wood, plastic, metal, cloth or paper, dried at room temperature and optionally annealed at 60° C. for 2 h to obtain the surface modified conducting substrate, exhibiting water repellence with a water contact angle >150°, providing a conducting superhydrophobic non-wetting surface. The measured conductivity was 1.2 S/cm, where as that for the coating without MWCNT was <10⁻⁹ S/cm, confirming a minimum of 10⁹ fold increase in conductivity. The conductivity can further be tuned by varying the amount of MWCNTs added.

Though tetrahydrofuran was the preferred solvent, non-limiting examples of solvents include alcohols such as methanol, ethanol, propanol, isopropanol, etc., hydrocarbons such as pentane, hexane, heptane, octane, decane, cyclohexane, benzene, toluene, acetonitrile, ether, etc. Further, any conducting additive, organic or inorganic, dispersible in the solvent may be used to generate emissive non-wetting coatings.

### Example 14. Antibacterial Activity

A single colony of the corresponding bacteria from a nutrient agar plate was transferred to 10 mL nutrient broth medium each and grown at 37° C. for 24 hours. LaPO₄-octadecyl phosphonic acid was suspended in sterile distilled water at a concentration of 25 mg/mL. 100 μL from this solution and 20 μL of bacteria were added to 5 mL of nutrient broth and incubated in dark for 2h. A control was kept with 100 μL sterile water instead of compound solution. After incubation, 100 μL from this solution was serially diluted up to 104 and plated on the Nutrient agar plates and the colonies formed after 24h incubation at 37° C. were counted as colony-forming units (CFUs). The experiment was conducted in triplicates for recording the data.

The antibacterial results are provided in FIG. 26. E. coli showed >90% reduction in growth when treated with the superhydrophobic composite.

### Advantages of the Invention

Simple synthetic procedure, no purification required
Know-how for preparing the starting material/commercial availability
Fluorine/fluoride free composition
White, multiple coloration possibilities
Scalable and Cost-effective
High water contact angles (152±5°)
Tunable sticky or slippery superhydrophobicity
Facile processability (drop, dip, spin or spray casting)
Multi-substrate compatibility (glass, metal, plastic, wood, cloth, paper)
Multifunctional No-wettable Coatings
Icephobic, Multi-color, Fluorescent, Conducting Superhydrophobic Coatings
Tunable towards multiple applications

1. A composite comprising a phosphate salt of an element selected from lanthanide series and an organic phosphonic acid,
wherein the phosphate salt is a phosphate salt of Lanthanum or Cerium or mixture thereof and the organic phosphonic acid is selected from the group consisting of alkyl, allyl and aryl phosphonic acids,
wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, OH, —CN, OR₁₋₃₀, NH₁₋₂R₀₋₃₀, N(R₁₋₃₀)₂, COOH, COOR₁₋₃₀, wherein R is a C₁-30 alkyl group;
wherein the phosphate salt of an element and the organic phosphonic acid is in a ratio in the range of 20:1 to 4:1 (w/w).

2. The composite as claimed in claim 1, wherein the phosphate salt of an element and the organic phosphonic acid is in a ratio of 10:1 (w/w).

3. The composite as claimed in claim 1, wherein the phosphate salt of an element and the organic phosphonic acid is in a ratio of 4:1 (w/w).

4. A process for preparing the composite as claimed in claim 1, said method comprising
(a) activating a phosphate salt of an element selected from lanthanide series by acid treatment to obtain an activated phosphate salt;
(b) mixing the activated phosphate salt obtained in step (a) with an organic phosphonic acid in a ratio in the range of 20:1 to 4:1 (w/w) in an organic solvent to obtain a mixture;
(c) stirring the mixture obtained in step (b) at 25-28° C. for 72 hours followed by centrifugation at 5000 rpm for 10 min twice and drying for 12 hours at 70° C. in hot air oven to obtain the composite.

5. The process for preparing the composite as claimed in claim 4, wherein the acid treatment of the phosphate salt of an element is carried out by steps comprising of:
i. adding a mineral acid and the phosphate salt of an element in water and refluxing at 110° C. for 12 hours to obtain a suspension;
ii. cooling the suspension to room temperature and centrifuging at 5000 rpm for 10 minutes;
iii. redispersing in water and centrifuging at 5000 rpm for 10 minutes twice;
iv. redispersing in alcohol and centrifuging at 5000 rpm for 10 minutes to obtain a solid powder; and
v. drying the solid powder for 12 hours at 70° C. in a hot air oven to obtain the activated phosphate salt of an element.

6. The process as claimed in claim 4, wherein the element from lanthanide series is selected from Lanthanum or Cerium.

7. The process as claimed in claim 4, wherein the organic phosphonic acid is selected from the group consisting of alkyl, allyl and aryl phosphonic acids,
wherein said alkyl groups comprises of C₂-C₂₅ alkyl chains with general formula CₙH₂ₙ₊₁, branched or unsaturated alkyl, said aryl groups comprises of phenyl, benzyl, or heteroaryl including pyridyl or terpyridynyl, OH, —CN, OR₁₋₃₀, NH₁₋₂R₀₋₃₀, N(R₁₋₃₀)₂, COOH, COOR₁₋₃₀, wherein R is a C₁₋₃₀ alkyl group.

8. The process as claimed in claim 4, wherein the organic solvent is selected from the group consisting of tetrahydrofuran, methanol, ethanol, propanol, isopropanol, pentane, hexane, heptane, octane, decane, cyclohexane, benzene, toluene, acetonitrile, and ether.

9. The process as claimed in claim 5, wherein the mineral acid is orthophosphoric acid and the alcohol is selected from propanol or iso-propanol.

10. A composition comprising the composite as claimed in claim 1 and an organic solvent, wherein the organic solvent is selected from the group consisting of methanol, ethanol, propanol, isopropanol, pentane, hexane, heptane, octane, decane, cyclohexane, benzene, toluene, acetonitrile, ether, and tetrahydrofuran.

11. The composition as claimed in claim 10, wherein the composition comprises a binder selected from polystyrene and the ratio of binder to composite is 1:20 (w/w).

12. The composition as claimed in claim 10, wherein the composition comprises a colouring agent selected from dye or ink.

13. The composition as claimed in claim 10, wherein the composition comprises a conductive additive selected from multi-walled carbon nanotubes and the ratio of multi-walled carbon nanotubes to composite is in the range of 1:25 to 1:10 (w/w).

14. The composition as claimed in claim 10, wherein the composition comprises an organic or inorganic fluorescent additive and the ratio of fluorescent additive to composite is in the range of 1:50 to 1:10 (w/w).

15. A water repellent surface comprising a substrate coated with the composition as claimed in claim 10, wherein the substrate is selected from the group consisting of glass, wood, plastic, metal, cloth and paper.

16. The composite as claimed in claim 1, wherein at least one said aryl group is substituted with a halogen.

17. The composite as claimed in claim 7, wherein at least one said aryl group is substituted with a halogen.
